(19) United States
(12) Patent Application Publication
(10) Pub. No.: US 2013/0107512 A1
(43) Pub. Date: May 2, 2013

(54) LED PLANT LIGHT

(71) Applicants: Ching-Cherng Sun, Yangmei City (TW); Yu-Yu Chang, Kaohsiung CIty (TW); Xuan-Hao Lee, Keelung City (TW)

(72) Inventors: Ching-Cherng Sun, Yangmei City (TW); Yu-Yu Chang, Kaohsiung CIty (TW); Xuan-Hao Lee, Keelung City (TW)

(73) Assignee: NATIONAL CENTRAL UNIVERSITY, Taoyuan County (TW)

(21) Appl. No.: 13/284,422

(22) Filed: Oct. 28, 2011

(51) Int. Cl. F21V 7/00; F21V 9/00

(52) U.S. Cl. 362/231; 362/277

(57) ABSTRACT

A LED plant light includes an optical reflector having at least one incident hole at the top and at least one emitting hole at the bottom thereof, a LED illuminant placed at the end of the incident hole, and a diffuser assembled to the bottom of the optical reflector and corresponding to the emitting hole for transmitting the light beam. The optical reflector is located between the LED illuminant and the diffuser. The optical reflector collects as much light as possible from the LED illuminant at first, and then the light are mixing on the diffuser to further transmit to the plant; if an illuminative range cannot completely cover a planting area, a user just adjusts the location of the diffuser in order to change the angle of the emitting light and to enlarge the illuminative range for giving the plant one uniform illumination.

### BACKGROUND OF THE INVENTION

1. Field of the Invention

The present invention relates to a plant light, more particularly to a LED plant light with diffusers to emit a uniform light for photosynthesis.

2. Description of Related Art

Plant lights are used for indoor gardening, plant propagation and food production, including indoor hydroponics and aquatic plants. Scientifically, the wavelength of the light within the red light and blue light range can promote plants to photosynthesize more efficiently. However, a traditional plant light with bulbs cannot provide a specific spectrum for plants. In addition, the life time of the tradition bulbs is too short to illuminate the plants indoors for 24 hours a day, seven days a week.

Recent advancements in LEDs allow production of relatively inexpensive, bright, and long-lasting plant lights that emit only the wavelengths of light corresponding to the absorption peaks of a plant's typical photochemical processes. Compared to other types of plant lights, LEDs are attractive to indoor growers since they consume much less electrical power and produce considerably less heat. This allows LEDs to be placed closer to the plant canopy than other lights. Also, the water of plants transpire less, as a result of the reduction in heat, and thus the time between watering cycles is longer.

Nevertheless, according to the inverse square law, the intensity of light radiating from a point source that reaches a surface is inversely proportional to the square of the surface's distance from the source which is a serious hurdle for indoor growers, and many techniques are employed to use light as efficiently as possible. Before the new technology comes to the world, to increase the amounts of the LED plant lights indoors is the common way to overcome insufficient intensity of light, but the result is much more consumption of the electrical power. The present invention has arisen to mitigate and/or obviate the disadvantages of the conventional.

### SUMMARY OF THE INVENTION

The main objective of the present invention is to provide an improved lamp with diffuser sheets for highly illuminative efficiency.

To achieve the objective, a lamp with diffuser sheets for highly illuminative efficiency comprises an optical reflector having at least one incident hole at the top thereof, the optical reflector having at least one emitting hole at the bottom thereof, a LED illuminant placed at the end of the incident hole, a diffuser assembled to the bottom of the optical reflector and corresponding to the emitting hole for transmitting the light beam, the optical reflector located between the LED illuminant and the diffuser; wherein the optical reflector collects as much light as possible from the LED illuminant at first, and then the light are mixing on the diffuser to further transmit to the plant; if an illuminative range cannot completely cover a planting area, a user just adjusts the location of the diffuser in order to change the angle of the emitting light and to enlarge the illuminative range for giving the plant one uniform illumination.

The LED illuminant further comprises at least one blue-light LED with wavelength from 350˜470 nm and at least one red-light LED with wavelength from 680˜870 nm. The optical reflector has a blue-light reflection surface and a red-light reflection surface. The blue-light reflection surface focuses and guides the blue-light beam to pass through the emitting hole. The red-light reflection surface focuses and guides the red-light beam to pass through the emitting hole. The ratio of the blue-light LED and the red-light LED can be adjusted in the LED illuminants for different kinds of plants to photosynthesize.

The diffuser has an emitting surface on the bottom thereof, the diffuser having an incident surface on the top thereof, the incident surface corresponding to the emitting hole for transmitting the light beam. The emitting surface or the incident surface is shaped as a paraboloid, a spherical surface or a flat plane.

The diffuser is moved up or down relative to the optical reflector for adjusting the size of the illuminative range because of the change of the emitting angle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a LED plant light in accordance with the present invention;

FIG. 2 is a cross-sectional view of the LED plant light in accordance with the present invention;

FIG. 3 is an assembled view of the LED plant light in accordance with the present invention;

FIG. 4 is a top view to show that the LED plant light is in use indoors for the plants.

### DETAILED DESCRIPTION OF THE INVENTION

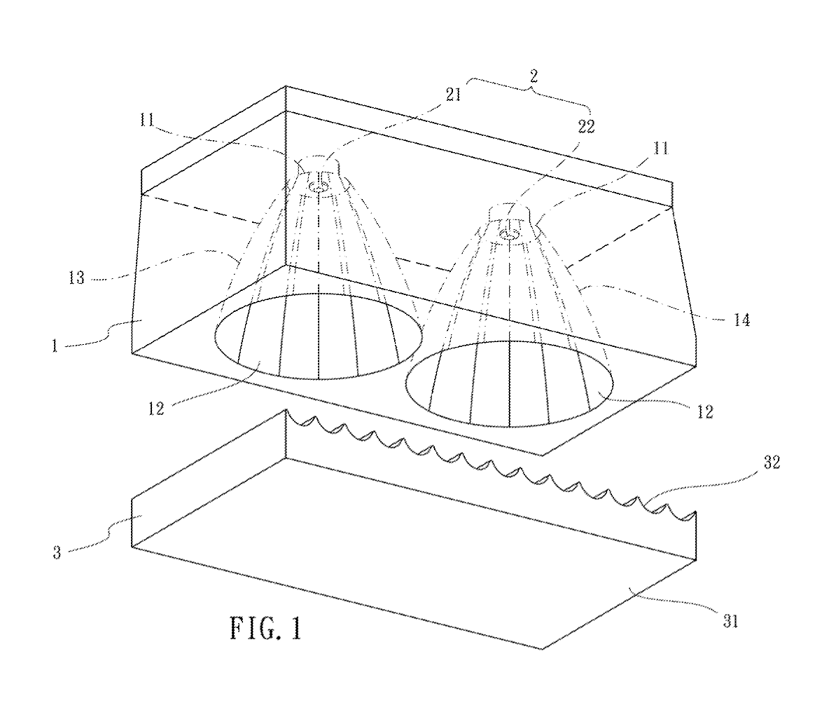

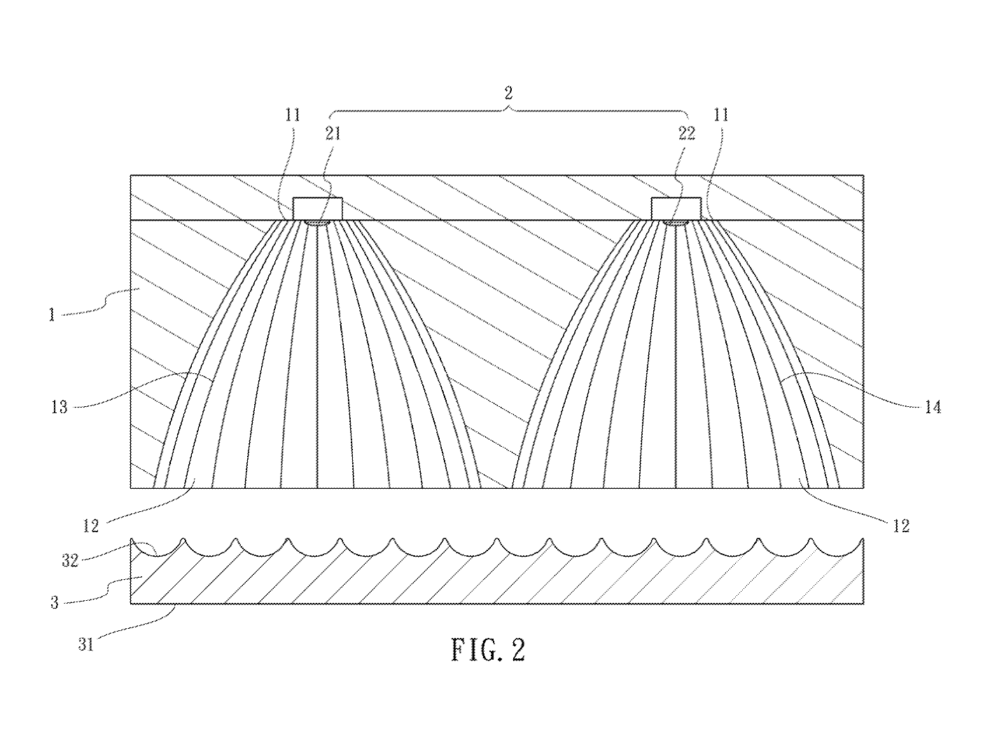

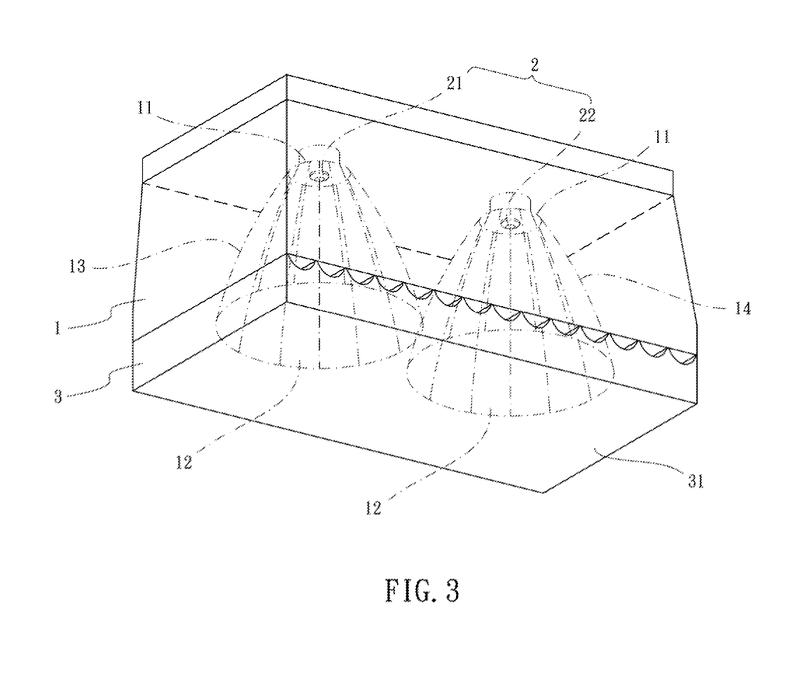

Referring to FIGS. 1-3, a LED plant light 4 in accordance with the present invention comprises an optical reflector 1, a LED illuminant 2 and a diffuser 3. The optical reflector 1 has at least one incident hole 11 at the top thereof. The optical reflector 1 has at least one emitting hole 12 at the bottom thereof In the present embodiment, there are two incident holes 11 and two emitting holes 12.

The LED illuminant 2 is placed at the end of the incident hole 11. The LED illuminant 2 further comprises at least one blue-light LED 21 with wavelength from 350˜470 nm and at least one red-light LED 22 with wavelength from 680˜870 nm for plants to photosynthesize. The blue-light LED 21 may trigger a greater vegetative response in the plants because the blue spectrum light promotes the plants to photosynthesize efficiently and benefits the cellular respiration of the plants. In addition, the blue spectrum light can trigger the plants to grow transversely instead of growing upward that is also beneficial for planting indoors. On the other hand, the red-light LED 22 may trigger a greater flowering response in the plants because the chlorophylls in the plant's cells can absorb the most of the red spectrum light perfectly and the red spectrum light is more beneficial for the plants to photosynthesize. Furthermore, the red spectrum light can trigger the leaves to grow and promote the plants to grow upward. The ratio of the blue-light LED 21 and the red-light LED 22 can be adjusted in the LED illuminants 2 for different kinds of plants. In the present embodiment, there are only one blue-light LED 21 and only one red-light LED 22 in the LED illuminant 2.

The optical reflector 1 has a blue-light reflection surface 13 and a red-light reflection surface 14. When the blue-light LED 21 emits a blue-light beam, the blue-light beam passes through one incident hole 11 to the blue-light reflection surface 13, thereafter the blue-light reflection surface 13 focuses the blue-light beam and the blue-light beam is guided to pass through one emitting hole 12. On the other hand, when the red-light LED 22 emits a red-light beam, the red-light beam passes through another incident hole 11 to the red-light reflection surface 14, thereafter the red-light reflection surface 14 focuses the red-light beam and the red-light beam is guided to pass through another emitting hole 12.

The diffuser 3 is assembled to the bottom of the optical reflector 1. The optical reflector 1 is located between the LED illuminant 2 and the diffuser 3. The diffuser 3 has an emitting surface 31 on the bottom thereof. The diffuser 3 has an incident surface 32 on the top thereof. The incident surface 32 is corresponding to the emitting hole 12 for transmitting the light beam. The emitting surface 31 or the incident surface 32 might be shaped as a paraboloid, a spherical surface or a flat plane. In the present embodiment, the emitting surface 31 is a flat planes and the incident surface 32 is a sequence of the paraboloids. When the diffuser 3 is moved up or down relative to the optical reflector 1, the size of an illuminative range 7 can be adjusted to illuminate the plants sufficiently because the emitting angle of the light beam is changed. The transmission rate of the diffuser 3 can reach to 90% and the total energy loss is less than 20% in the present invention. Moreover, the optical energy loss is less than 15.3% in the present invention.

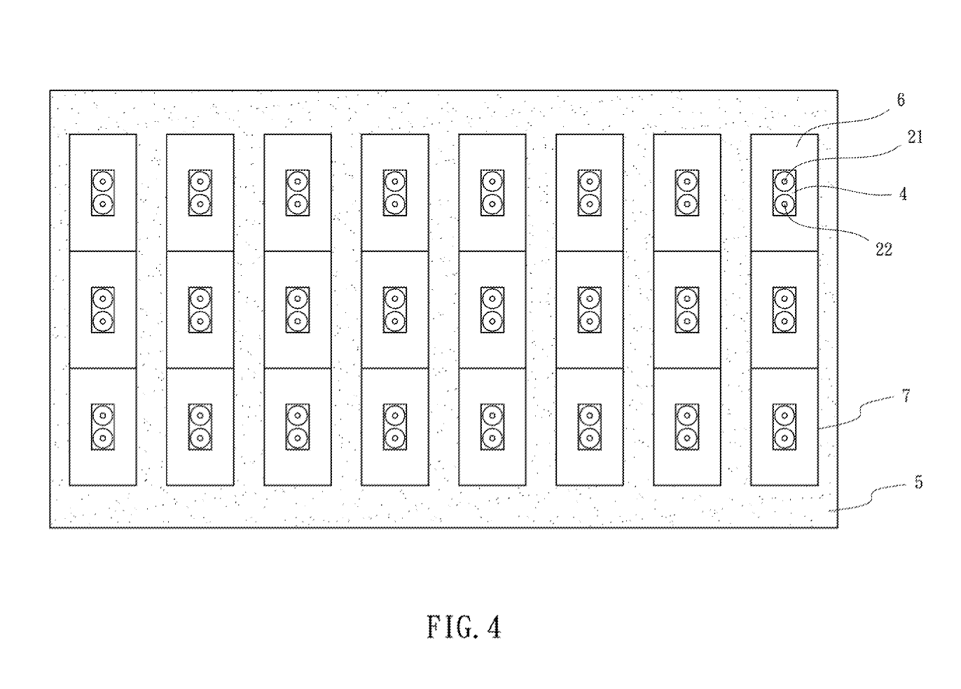

Referring to FIG. 4, the LED plant light 4 is used to illuminate an area full of soil 5. When the area full of soil 5 is planted many kinds of vegetables, the area full of soil 5 is divided into a plurality of planting areas 6. After the location of the diffuser 3 is adjusted, each of the illuminative ranges 7 is adjusted for each vegetable planted in the planting area 6. The LED plant lights 4 can be disposed conveniently for different kinds of vegetables in the area full of soil 5.

All in all, the optical reflector 1 collects as much light as possible from the LED illuminant 2 at first, and then the light are mixing on the diffuser 3 to further transmit to the plant. If the illuminative range 7 cannot completely cover the planting area 6, a user just adjusts the location of the diffuser 3 in order to change the angle of the emitting light and to enlarge the illuminative range 7 for giving the plant one uniform illumination. In addition, comparing the LED plant light 4 with the traditional plant light with bulbs, the LED plant light 4 can save more than 50% electrical power.

Although the invention has been explained in relation to its preferred embodiment, it is to be understood that many other possible modifications and variations can be made without departing from the spirit and scope of the invention as hereinafter claimed.

What is claimed is:

1. A LED plant light comprising:
an optical reflector having at least one incident hole at the top thereof, the optical reflector having at least one emitting hole at the bottom thereof;
a LED illuminant placed at the end of the incident hole; and
a diffuser assembled to the bottom of the optical reflector and corresponding to the emitting hole for transmitting the light beam, the optical reflector located between the LED illuminant and the diffuser;
wherein the optical reflector collects as much light as possible from the LED illuminant at first, and then the light are mixing on the diffuser to further transmit to the plant; if an illuminative range cannot completely cover a planting area, a user just adjusts the location of the diffuser in order to change the angle of the emitting light and to enlarge the illuminative range for giving the plant one uniform illumination.

2. The LED plant light as claimed in claim 1, wherein the LED illuminant further comprises at least one blue-light LED with wavelength from 350˜470 nm and at least one red-light LED with wavelength from 680˜870 nm.

3. The LED plant light as claimed in claim 2, wherein the optical reflector has a blue-light reflection surface and a red-light reflection surface, the blue-light reflection surface focusing and guiding the blue-light beam to pass through the emitting hole, the red-light reflection surface focusing and guiding the red-light beam to pass through the emitting hole.

4. The LED plant light as claimed in claim 2, wherein the ratio of the blue-light LED and the red-light LED can be adjusted in the LED illuminants for different kinds of plants to photosynthesize.

5. The LED plant light as claimed in claim 1, wherein the diffuser has an emitting surface on the bottom thereof, the diffuser having an incident surface on the top thereof, the incident surface corresponding to the emitting hole for transmitting the light beam.

6. The LED plant light as claimed in claim 5, wherein the emitting surface or the incident surface is shaped as a paraboloid, a spherical surface or a flat plane.

7. The LED plant light as claimed in claim 1, wherein the diffuser is moved up or down relative to the optical reflector for adjusting the size of the illuminative range because of the change of the emitting angle.
